(19) United States
(12) Patent Application Publication
(10) Pub. No.: US 2025/0349822 A1
(43) Pub. Date: Nov. 13, 2025

(54) METHOD AND APPARATUS FOR THE DRY, SOLVENT FREE MANUFACTURE OF ELECTRODES USING POWDERS

(71) Applicant: The Texas A&M University System, College Station, TX (US)

(72) Inventors: Heng Pan, St. Louis, MO (US); Zhongjia Gao, College Station, TX (US); Chinmoy Podder, College Station, TX (US)

(73) Assignee: The Texas A&M University System, College Station, TX (US)

(21) Appl. No.: 18/871,770

(22) PCT Filed: Jun. 27, 2023
(86) PCT No.: PCT/US2023/069175

§ 371 Date: Dec. 4, 2024

Related U.S. Application Data
(60) Provisional application No. 63/355,727, filed on Jun. 27, 2022.

(51) Int. Cl. H01M 4/04; H01M 4/62

(52) U.S. Cl. CPC H01M 4/0404; H01M 4/0435; H01M 4/622

(57) ABSTRACT

A system for dry manufacturing an electrode for an energy storage device includes a substrate configured to move in a feed direction. In addition, the system includes a powder applicator configured to deposit a dry powder onto a surface of the substrate. Further, the system includes at least one pair of spreading rollers. The pair of spreading rollers includes an upper spreading roller and a lower spreading roller positioned below the upper spreading roller. The upper spreading roller and the lower spreading roller are positioned downstream of the powder applicator relative to the feed direction. Each spreading roller has a central axis of rotation and a radially outer surface. The radially outer surface of the upper spreading roller is configured to directly contact and spread the dry powder on the substrate. The upper spreading roller is configured to rotate in a rotational direction that is counter to the feed direction of the substrate proximal the substrate and dry powder and the lower spreading roller is configured to rotate in a rotational direction that is the same as the rotational direction of the upper spreading roller. Still further, the system includes at least one pair of compaction rollers. The pair of compaction rollers includes an upper compaction roller and a lower compaction roller positioned below the upper compaction roller. The at least one pair of spreading rollers are positioned downstream of the upper spreading roller and the lower spreading roller relative to the feed direction. Each compaction roller has a central axis of rotation and a radially outer surface. The radially outer surface of the upper compaction roller is configured to directly contact and compress the dry powder to form the electrode on the surface of the substrate. The upper compaction roller is configured to rotate in a rotational direction that is opposite to the rotational direction of the upper spreading roller.

### CROSS-REFERENCE TO RELATED APPLICATIONS

This application is a 35 U.S.C. § 371 national stage application of PCT/US2023/069175 filed Jun. 27, 2023 and entitled “Method and Apparatus for the Dry, Solvent Free Manufacture of Electrodes Using Powders,” which claims benefit of U.S. provisional patent application Ser. No. 63/355,727 filed Jun. 27, 2022 and entitled “Method and Apparatus for Dry Manufacturing of Electrode Using Powders,” each of which is hereby incorporated herein by reference in its entirety for all purposes.

### STATEMENT REGARDING FEDERALLY SPONSORED RESEARCH OR DEVELOPMENT

Not applicable.

### BACKGROUND

The disclosure relates generally to manufacturing methods and apparatus. More particularly, the disclosure relates to methods and apparatus for dry manufacturing electrodes for energy storage devices such as batteries (e.g., lithium ion batteries, solid state batteries, etc.).

Li-ion battery (LIB) production capacity is projected to grow significantly in the coming years. Consequently, it is anticipated that about a 4× increase of manufacturing capacity will need to be added over the next decade to meet the demand for Li-ion batteries. Argonne National Lab has estimated that the battery electrode manufacturing equipment alone may cost about $66 million for each 5 GWh plant. To build up 1,000 GWh of new capacity, 200 such plants need to be constructed.

The rapid growth in battery manufacturing imposes significant impacts on energy consumption and greenhouse gas emissions. For example, a current 5 GWh Li-ion battery plant consumes about 565 GWh/year of electricity. In particular, conventional methods for manufacturing electrodes for Li-ion batteries utilize slurry casting techniques that require energy intensive drying, environmentally hazardous solvents, and a relatively large footprint.

All Solid-State Batteries (ASSB) technology is expected to become dominant battery technology in the coming years for its promise in safer and more energy-dense batteries. However, solid-state batteries place new requirements and challenges on battery electrode manufacturing including film thickness, uniformity and electrolyte-active material interfaces. In particular, many organic polar solvents are detrimental to solid-state electrolytes (SSE). The poor compatibility of solid state electrolytes with solvents are significant factors that impede the commercialization of select types of solid electrolyte based all solid-state batteries. Consequently, conventional slurry-based battery manufacturing technology that relies on solvents cannot be directly applied to manufacture thin film solid-state electrolytes and composite electrodes for all solid-state batteries. To circumvent solvent compatibility issues, solvent-free or dry mixing-based palletization processes, wherein solid-state electrolytes, additives and actives materials are dry-mixed followed by mechanical pressing processes, has been attempted in lab scale fabrication. However, such dry mixing-based palletization processes have challenges in scalable manufacturing.

### BRIEF SUMMARY OF THE DISCLOSURE

Embodiments of systems for dry manufacturing electrodes for energy storage devices are disclosed herein. In one embodiment, a system for dry manufacturing an electrode for an energy storage device comprises a substrate configured to move in a feed direction. In addition, the system comprises a powder applicator configured to deposit a dry powder onto a surface of the substrate. Further, the system comprises at least one pair of spreading rollers. The at least one pair of spreading rollers comprises an upper spreading roller and a lower spreading roller positioned below the upper spreading roller. The upper spreading roller and the lower spreading roller are positioned downstream of the powder applicator relative to the feed direction. Each spreading roller has a central axis of rotation and a radially outer surface, wherein the radially outer surface of the upper spreading roller is configured to directly contact and spread the dry powder on the substrate. The upper spreading roller is configured to rotate in a rotational direction that is counter to the feed direction of the substrate proximal the substrate and dry powder, and the lower spreading roller is configured to rotate in a rotational direction that is the same as the rotational direction of the upper spreading roller. Still further, the system comprises at least one pair of compaction rollers. The at least one pair of compaction rollers comprises an upper compaction roller and a lower compaction roller positioned below the upper compaction roller. The upper compaction roller and the lower compaction roller are positioned downstream of the at least one pair of spreading rollers relative to the feed direction. Each compaction roller has a central axis of rotation and a radially outer surface. The radially outer surface of the upper compaction roller is configured to directly contact and compress the dry powder to form the electrode on the surface of the substrate. The upper compaction roller is configured to rotate in a rotational direction that is opposite to the rotational direction of the upper spreading roller.

Embodiments of methods for dry manufacturing electrodes for energy storage devices are disclosed herein. In one embodiment, a method for dry manufacturing an electrodes for an energy storage device comprises (a) depositing a dry powder onto a surface of a substrate moving in a feed direction. In addition, the method comprises (b) transporting the dry powder on the substrate beneath a first spreading roller rotating in a first rotational direction to spread the dry powder on the substrate after (a). The first rotational direction is counter to the feed direction at a point of contact of the first spreading roller with the dry powder. Further, the method comprises (c) transporting the dry powder with the substrate beneath a compaction roller rotating in a second rotational direction that is opposite to the first rotational direction to compress the dry powder composition after (b) and produce the electrode on the surface of the substrate.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various exemplary embodiments, reference will now be made to the accompanying drawings in which:

FIG. 1 is a schematic side view an embodiment of a system for dry-manufacturing electrodes for energy storage devices in accordance with principles described herein;

FIG. 2A is a schematic view of an exemplary micro-particle and a plurality of exemplary nano-particles that can be used to form the dry powder of FIG. 1;

FIG. 2B is a schematic view of an exemplary nano-particle coated micro-particle formed from the exemplary micro-particle and exemplary nano-particles of FIG. 2A;

FIG. 3 is a schematic side view an embodiment of a system for dry-manufacturing electrodes for energy storage devices in accordance with principles described herein; and

FIG. 4 is a schematic view of an embodiment of a method for drying manufacturing electrodes for energy storage devices in accordance with principles described herein.

### DETAILED DESCRIPTION OF THE PREFERRED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct engagement between the two devices, or through an indirect connection that is established via other devices, components, nodes, and connections. In addition, as used herein, the terms “axial” and “axially” generally mean along or parallel to a particular axis (e.g., central axis of a body or a port), while the terms “radial” and “radially” generally mean perpendicular to a particular axis. For instance, an axial distance refers to a distance measured along or parallel to the axis, and a radial distance means a distance measured perpendicular to the axis. Any reference to up or down in the description and the claims is made for purposes of clarity, with “up”, “upper”, “upwardly”, “uphole”, or “upstream” meaning toward the surface of the borehole and with “down”, “lower”, “downwardly”, “downhole”, or “downstream” meaning toward the terminal end of the borehole, regardless of the borehole orientation. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

As described above, conventional methods for manufacturing electrodes for energy storage devices (e.g., Li-ion batteries, all solid state batteries, etc.) typically have high energy demands, rely on environmentally hazardous solvents, may require a relatively large footprint, and may not be scalable for large scale production. Accordingly, embodiments of systems and methods disclosed herein for manufacturing electrodes for energy storage devices are directed to solvent free (or “dry”) techniques that are environmentally friendly, and that offer the potential to reduce energy consumption and greenhouse gas emissions. For example, it is estimated that dry electrode manufacturing systems and methods disclosed herein may offer up to about a 40% reduction in electricity consumption as compared to the conventional slurry casting technology for manufacturing electrodes for Li-ion batteries. In particular, switching from the conventional slurry casting techniques to embodiments of dry electrode manufacturing systems and methods as described herein offers the potential to reduce the annual electricity consumption by 226 GWh and CO2 emission of 94,000 tons for a 5 GWh Li-ion battery plant. Based on the projected Li-ion battery production of 1,300 GWh in 2030, the annual reduction of electricity consumption and CO2 emissions may be 58,760 GWh and 24,440,00 tons, respectively, via switching to dry, solvent free electrode manufacture systems and methods as described herein. Much of these reductions are due to reduced energy usage by eliminating requirements for solvent drying and solvent recovery. Although these estimates are based on Li-ion battery manufacturing, it is expected that the manufacturing of all solid-state batteries will follow a similar trend.

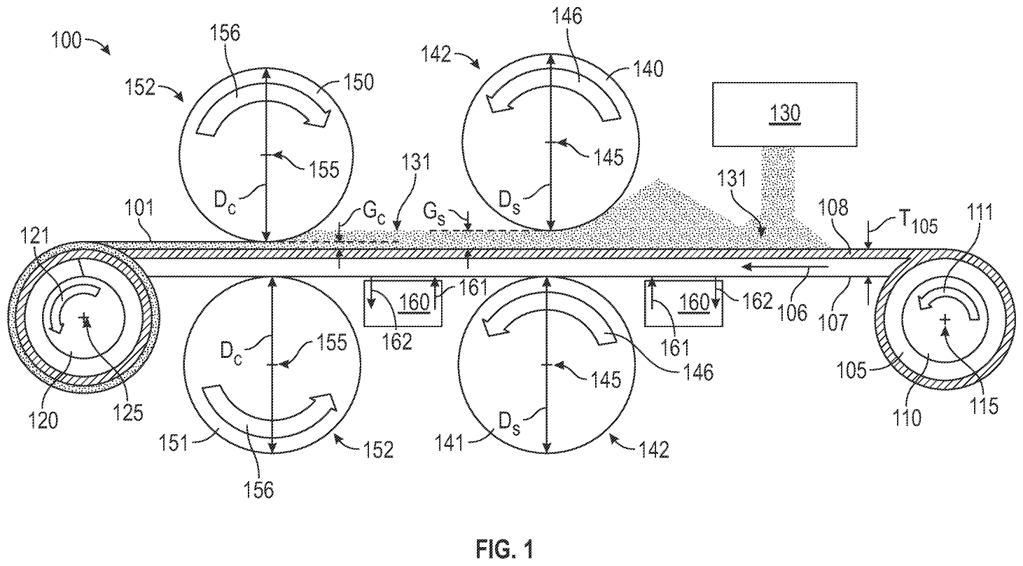

Referring now to FIG. 1, an embodiment of a system 100 for dry manufacturing electrodes for energy storage devices such as Li-ion batteries and all solid-state batteries is shown. More specifically, system 100 produces a continuous sheet or layer of electrode material 101 on a web or substrate 105. The electrode material 101 and substrate 105 can be cut as desired to produce a plurality of individual electrodes for use in energy storage devices. Accordingly, for purposes of clarity and further explanation, electrode material 101 may also be referred to herein as electrode 101.

In this embodiment, system 100 includes an unwinding or supply roller 110, a winding or receiving roller 120 horizontally spaced from the supply roller 110, a powder feeder or applicator 130, a pair of vertically arranged spreading rollers 140, 141, a pair of vertically arranged compaction rollers 150, 151 horizontally spaced from the spreading rollers 140, 141, and a plurality of horizontally spaced air bearings 160. Spreading rollers 140, 141 are horizontally positioned between compaction rollers 150, 151 and supply roller 110, and compaction rollers 150, 151 are horizontally positioned between winding roller 120 and spreading rollers 140, 141. In this embodiment, one air bearing 160 is horizontally positioned between supply roller 110 and spreading rollers 140, 141 and the other air bearing 160 is horizontally positioned between spreading rollers 140, 141 and compaction rollers 150, 151. Although one pair of spreading rollers 140, 141 and one pair of compaction rollers 150, 151 are shown in FIG. 1, it should be appreciated that in other embodiments, two or more pairs of serially spreading rollers (e.g., spreading rollers 140, 141) and/or two or more pairs of serially arranged compaction rollers (e.g., compaction rollers 150, 151) may be provided with each spreading roller positioned between the supply roller (e.g., supply roller 110) and the compaction roller(s) (e.g., compaction rollers 150, 151). In addition, system 100 shown in FIG. 1 includes the same number of pairs of spreading rollers 140, 141 and compaction rollers 150, 151 (one pair of spreading rollers 140, 141 and one pair of compaction rollers 150, 151), in other embodiments, the number of pairs of spreading rollers (e.g., spreading rollers 140, 141) and the number of pairs of compaction rollers (e.g., compaction rollers 150, 151) can be different (e.g., one pair of spreading rollers 140, 141 and multiple pairs of compaction rollers 150, 151, or vice versa).

Supply roller 110 generally provides a continuous sheet of substrate 105 on which electrode 101 is formed with system 100. Substrate 105 can be unwound from supply roller 110, or provided by another roller (not shown) and passed over supply roller 110 to the remainder of system 100. Supply roller 110 rotates in a rotational direction 111 about a central axis 115 to supply substrate 105 in a generally horizontal feed direction 106 through system 100. As shown in FIG. 1, rotational direction 111 is counterclockwise and feed direction 106 is to the left. In embodiments described herein, substrate 105 is fed from supply roller 110 and moved in feed direction 106 at a feed rate or speed greater than 0.0 m/min and less than or equal to 80.0 m/min.

Receiving roller 120 generally receives the continuous sheet of substrate 105 and electrode 101 formed thereon. Substrate 105 and electrode 101 can be wound onto receiving roller 120, or passed over receiving roller 120 to another roller (not shown). Receiving roller 120 rotates in a rotational direction 121 about a central axis 125 to receive substrate 105 and electrode 101 along the generally horizontal feed direction 106. As shown in FIG. 1, rotational direction 121 is counterclockwise, and thus, is the same as rotational direction 111 of supply roller 110. As previously described, in embodiments described herein, substrate 105 is moved in feed direction 106 at a feed rate or speed ranging greater than 0.0 m/min and less than or equal to 80.0 m/min, and thus, substrate 105 and electrode 101 formed thereon are received by receiving roller 120 at that same rate.

In embodiments described herein, substrate 105 preferably comprises a conductive base 107 in the form of a sheet of conductive material and a friction enhancing coating 108 applied to the upper surface of base 107. In general, base 107 can be a sheet of any suitable conductive material including, without limitation, a sheet of aluminum foil or a sheet of copper foil. Friction enhancing coating 108 on the surface of base 107 can be any suitable material for (i) increasing the coefficient of friction between the surface of substrate 105 and dry powder 131 and (ii) increasing the adhesion between electrode 101 and substrate 105 including, without limitation, a carbon coating or a polyvinylidene fluoride (PVDF) coating. In an embodiment, base 107 is aluminum foil and friction enhancing coating 108 is carbon. Substrate 105 has a thickness T₁₀₅ measured perpendicularly between its upper and lower surfaces. In embodiments, described herein, the thickness T₁₀₅ of substrate 105 ranges from 1.0 micron to 200.0 micron, and alternatively ranges from 1.0 micron to 30.0 micron.

Powder applicator 130 supplies a dry powder 131 that forms electrode 101 on substrate 105. In particular, powder applicator 130 applies dry powder 131 onto the upper surface of substrate 105, which carries and moves dry powder 131 in feed direction 105 to spreading rollers 140, 141 and then compaction rollers 150, 151. Spreading rollers 140, 141 spread dry powder 131 on substrate 105, and then compaction rollers 150, 151 compact the spread dry powder 131 on substrate 105 to form electrode 101 on substrate 105. For most electrode manufacturing operations, the mass feed rate of dry powder 131 onto substrate 105 is greater than 0.0 gram/s and less than or equal to 20.0 gram/s per 100 mm of width of substrate 105. It is to be understood that dry powder 131 is “dry,” meaning it does not include any solvent.

In embodiments in which electrode 101 is manufactured for use in Li-ion batteries, dry powder 131 includes an active material, a binder, and a conductive additive (each in a powder form). Optionally, one or more solid state electrolytes (also in a powder form) can be included in dry powder 131 when electrode 101 is manufactured for use in solid state Li-ion batteries. The active material can include, without limitation, cathode materials such as lithium nickel-cobalt-manganese oxide (NMC), lithium iron phosphate (LFP), lithium cobalt oxide (LCO), or combinations thereof; and anode materials such as graphite, carbonaceous anode materials (e.g., graphite, graphene, disordered carbon, and the like), lithium transition metal oxides, Si-based composites, or combinations thereof. The binder can include, without limitation, a polymeric material, one or more of polyvinylidene fluoride (PVDF), polytetrafluoroethylene (PTFE), Polyacrylic acid (PAA), Polyethylene oxide (PEO), Polytetrafluoroethylene (PTFE), Poly(methyl methacrylate) (PMMA), Carboxymethyl Cellulose (CMC), Styrene-Butadiene Rubber (SBR), Polyurethanes, Ethylene Vinyl Acetate (EVA), acrylic polymers, and Polyethylene (PE). The conductive additive can include, without limitation, one or more of carbon black, carbon nanotubes, carbon fibers, graphene, or the like. The one or more solid state electrolytes can include, without limitation, solid polymer electrolyte PEO/LiTFSI, Lithium Lanthanum Zirconium Oxide (LLZO), Lithium lanthanum titanate (LLTO), Li₃InCl₆, Li₆PS₅Cl, silica nanofillers, Al₂O₃ nanofillers, LLZO nanofillers, or combinations thereof. In some embodiments, the solid state electrolyte can function as a binder, in which case the binder may be described as comprising a solid state electrolyte.

In embodiments in which electrode 101 is manufactured for use in all-solid-state batteries, dry powder 131 includes an active material (same as described above for use in Li-ion batteries), a solid-state electrolyte (same as described above for use in Li-ion batteries), and an additive (each in a powder form). The additive can include, without limitation, a binder (same as described above for use in Li-ion batteries), a conductive additive (same as described above for use in Li-ion batteries), or combinations thereof.

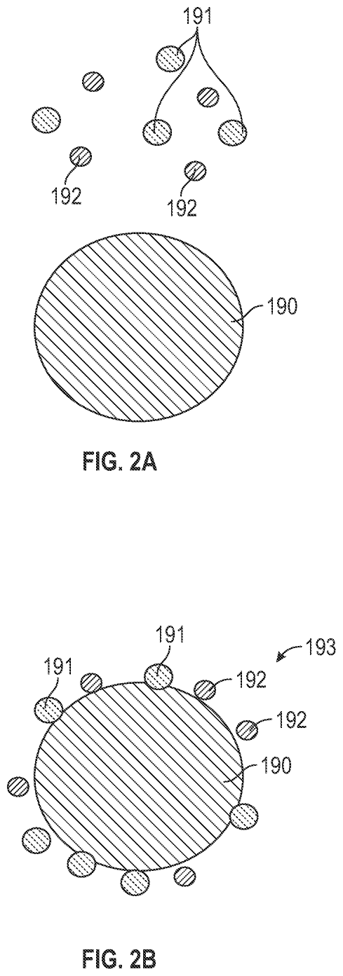

Regardless of whether electrode 101 is manufactured for use in a Li-ion battery or all-solid-state battery, dry powder 131 comprises at least 70 wt % active material and less than 30 wt % other components. In addition, dry powder 131 preferably comprises a plurality of micro-particles at least partially coated in a plurality of nano-particles (i.e., each micro-particle is at least partially coated in a plurality of nano-particles). As used herein, the term “micro-particle” refers to a particle having a size (e.g., diameter) greater than or equal to 1.0 micron, and the term “nano-particle” refers to a particle having a size (e.g., diameter) less than 1.0 micron. Thus, in embodiments described herein, the micro-particles in dry powder 131 have sizes that are preferably at least 10× the size of the nano-particles. The sizes of the components in dry powder 131 (e.g., active material, binder, conductive additive, solid state electrolytes, etc.) can range from nanometers (e.g., nano-particles) to tens of microns (e.g., micro-particles). For example, the active materials may have sizes ranging from 0.5 micron to 40 microns, whereas the conductive additives and some of the solid polymer electrolyte (e.g., nanofillers) can have sizes less than 1 micron. In general, any one or more of the individual components in dry powder 131 (e.g., active material, binder, conductive additive, solid state electrolytes, etc.) can serve as the micro-particles, and any one or more of the individual components in dry powder 131 (e.g., active material, binder, conductive additive, solid state electrolytes, etc.) can serve as the nano-particles. For example, referring briefly to FIG. 2A, a single active material micro-particle 190, a plurality of conductive additive nano-particles 191, and a plurality of solid state electrolyte nano-particles 192 are shown. The active material micro-particle 190 has a size that is at least 10× the size of the conductive additive nano-particles 191 and the solid state electrolyte nano-particles 192. In FIG. 2B, the active material micro-particle 190 is shown coated in the conductive additive nano-particles 191 and the solid state electrolyte nano-particles 192 to form one nano-particle coated micro-particle 193. A plurality of such nano-particle coated micro-particles 193 can be used as dry powder 131.

Without being limited to this or any particular theory, the nano-particle coated micro-particles in dry powder 131 advantageously exhibit reduced cohesiveness and shear thinning characteristics of dry powder 131, which enhances the flowability of dry powder 131 during spreading and compaction on substrate 105 to advantageously allow for the dry-cast, continuous and uniform formation of electrode 101. In particular, it is believed the nano-particle coated micro-particles can reduce cohesion and friction under increasing shear rates. The nano-particle coated micro-particles forming dry powder 131 are prepared by any suitable means known in the art (e.g., dry mixing) and then added to powder applicator 130 for controlled deposition on substrate 105.

Referring still to FIG. 1, spreading rollers 140, 141 uniformly spread dry powder 131 on the upper surface and friction enhancing coating 108 of substrate 105. Spreading rollers 140, 141 are vertically arranged one-above-the-other, and thus, may be described as an upper spreading roller 140 and a lower spreading roller 141. Each spreading roller 140, 141 has a central axis 145 about which it rotates in a rotational direction 146, a radially outer cylindrical surface 142, and an outer diameter Dₛ. In this embodiment, spreading rollers 140, 141 are positioned such that central axes 145 are disposed in a common vertical plane. However, in other embodiments, the central axes of the spreading rollers (e.g., central axes 145 of spreading rollers 140, 141) do not lie in a common vertical plane. Consequently, the uppermost portion of outer surface 142 of lower roller 141 is directly, vertically opposed the lowermost potion of outer surface 142 of upper roller 140. The lower portion of upper roller 140 directly contacts and spreads dry powder 131 on substrate 105, while the upper portion of lower roller 141 directly contacts and supports the lower surface of substrate 105. In this embodiment, the upper portion of lower spreading roller 141 is positioned slightly above the upper portion of supply roller 110 such that substrate 105 slopes slightly upward as it moves from supply roller 110 to spreading rollers 140, 141. More specifically, in some embodiments, substrate 105 slopes upward moving from supply roller 110 to spreading rollers 140, 141 at an angle greater than 0.0° and less than or equal to 15.0° relative to horizontal. In other embodiments, substrate 105 may not slope upward moving from supply roller 110 to spreading rollers 140, 141, but rather, may be horizontally oriented therebetween.

Outer diameter Dₛ of each spreading roller 140, 141 ranges from 5.0 mm to 200.0 mm. In this embodiment, the outer diameters Dₛ of spreading rollers 140, 141 are the same, however, in other embodiments, the outer diameters Dₛ of spreading rollers 140, 141 may be different.

Each spreading roller 140, 141 rotates about its corresponding axis 145 at a uniform rotational speed. In embodiments described herein, the rotational speed of each spreading roller 140, 141 preferably ranges from 0.1 to 200.0 RPM. In this embodiment, both spreading rollers 140, 141 have the same rotational speed, however, in other embodiments, the rotational speeds of spreading rollers 140, 141 can be different.

Rotational directions 146 of spreading rollers 140, 141 are the same. For example, in FIG. 1, rotational directions 146 of spreading rollers 140, 141 are both counterclockwise. However due to the positioning of spreading rollers 140, 141 above and below, respectively, substrate 105 and dry powder 131, rotational direction 146 of upper spreading roller 140 is generally opposite to feed direction 106 proximal substrate 105 and dry powder 131, whereas rotational direction 146 of lower spreading roller 141 is generally in the same direction as feed direction proximal substrate 105. In particular, due to the rotational direction 146 of upper spreading roller 140, the lower portion of outer surface 142 of upper spreading roller 140 contacting dry powder 131 moves in a direction opposite feed direction 106; however, due to the rotational direction 146 of lower spreading roller 141, the upper portion of outer surface 142 of lower spreading roller 141 contacting substrate 105 moves in the same direction as feed direction 106. For example, as shown in FIG. 1, at the point of engagement of outer surface 142 of upper spreading roller 140 with dry powder 131, outer surface 142 of upper spreading roller 140 is generally moving to the right while feed direction 106 is to the left; and at the point of engagement of outer surface 142 of lower spreading roller 141 with substrate 105, outer surface 142 of lower spreading roller 141 is generally moving to the left while feed direction 106 is to the left. Accordingly, upper spreading roller 140 may be described as “counter-rotating” relative to feed direction 106. The counter-rotation of upper spreading roller 140 that contacts dry powder 131 offers the potential for improved uniformity in spreading of dry powder 131 on substrate 105 (e.g., a more uniform thickness of the spread dry powder 131 on substrate 105).

Spreading rollers 140, 141 are vertically-spaced apart a sufficient distance to provide a gap Gₛ measured vertically from the upper surface of substrate 105 to the lowermost portion of outer surface 142 of upper spreading roller 140. Thus, the vertical distance between spreading rollers 140, 141 is equal to the thickness T₁₀₅ plus gap Gₛ. It should be appreciated that gap Gₛ defines the vertical thickness to which dry powder 131 is spread on substrate 105 by spreading rollers 140, 141. In embodiments described herein, gap Gₛ, and hence the vertical thickness of dry powder 131 after passing between spreading rollers 140, 141, ranges from 0 to 2,000 micron, and alternatively ranges from 20.0 micron to 500.0 micron.

In embodiments described herein, outer cylindrical surface 142 of counter-rotating spreading roller 140 that directly contacts dry powder 131 is preferably a low friction surface to reduce friction between spreading roller 140 and dry powder 131. The low friction surface preferably exhibits an average surface roughness Ra less than 0.05 micron, and alternatively less than 0.02 micron. In general, the low friction surface can be defined by a surface treatment or a coating. Examples of surface treatments and coatings include, without limitation, a polished surface, a carbide coating, a ceramic coating, chrome-plating, a PTFE coating, and a graphite coating (or the entire roller 140 can be made of a graphite material).

As previously described, upper spreading roller 140 that contacts dry powder 131 preferably has a friction reducing outer surface 142, and the upper surface of substrate 105 that directly contacts dry powder 131 preferably comprises a friction enhancing coating 108. More specifically, the coefficient of friction between substrate 105 and dry powder 131 (μ_{substrate-powder}) is preferably greater than the coefficient of friction between spreading roller 141 and dry powder 131 (μ_{roller-powder}). The combination of these features advantageously offers the potential to ensure continuous dry-casting of dry powder 131 via counter-rotating spreading rollers 140, 141 by maintaining the minimum principle stresses applied to dry powder 131 between spreading roller 140 and substrate 105 greater than or equal to zero.

To achieve the desired uniformity in the thickness of dry powder 131 after passing between spreading rollers 140, 141 (i.e., uniformity in gap Gₛ along both the length and the width of substrate 105), spreading rollers 140, 141 are preferably manufactured and oriented relative to each other with relatively tight tolerances. More specifically, each spreading roller 140, 141 preferably has a radial run-out error after manufacture and assembly less than or equal to 3.0 micron, and alternatively less or equal to 1.0 micron; and spreading rollers 140, 141 are preferably oriented such rollers 140, 141 exhibit a roller parallelism less than or equal to 5.0 micron, and alternatively less than or equal to 1.0 micron. As used herein, the terms “radial run-out error” and “roller parallelism” have meanings as are known in the art. Specifically, the term “radial run-out error” refers to the variation in the outer radius (difference between the maximum and minimum radius) of a roller; and the term “roller parallelism” refers to the variation in the distance (difference between the maximum and minimum distances) between the central axes of roller oriented substantially parallel to each other.

Referring again to FIG. 1, compaction rollers 150, 151 uniformly compact the spread dry powder 131 (after it has passed through spreading rollers 140, 141) on the upper surface and friction enhancing coating 108 of substrate 105. Compaction rollers 150, 151 are vertically arranged one-above-the-other, and thus, may be described as an upper compaction roller 150 and a lower compaction roller 151. Each compaction roller 150, 151 has a central axis 155 about which it rotates in a rotational direction 156, a radially outer cylindrical surface 152, and an outer diameter D_{c}. Compaction rollers 150, 151 are positioned such that central axes 155 are disposed in a common vertical plane. However, in other embodiments, the central axes of the compaction rollers (e.g., central axes 155 of spreading rollers 150, 151) do not lie in a common vertical plane. Consequently, the uppermost portion of outer surface 152 of lower roller 151 is directly, vertically opposed the lowermost potion of outer surface 152 of upper roller 150. The lower portion of upper roller 150 directly contacts and compacts dry powder 131 on substrate 105, while the upper portion of lower roller 151 directly contacts and supports the lower surface of substrate 105. In embodiments described herein, compaction rollers 150, 151 can apply a compaction load of up to about 3.5 tons/cm to spread dry powder 131 (along a line contact between roller 150 and dry powder 131), and more preferably apply a compaction load ranging from 0.1 to 1.5 tons/cm to spread dry powder 131 (along a line contact between roller 150 and dry powder 131).

Outer diameter D_{c} of each compaction roller 150, 151 ranges from 100.0 mm to 300.0 mm. In this embodiment, the outer diameters D_{c} of compaction rollers 150, 151 are the same, however, in other embodiments, the outer diameters D_{c} of compaction rollers 150, 151 may be different. Each compaction roller 150, 151 rotates about its corresponding axis 155 at a uniform rotational speed. In embodiments described herein, the rotational speed of each compaction roller 150, 151 preferably ranges from 0.1 to 80.0 RPM. In this embodiment, both compaction rollers 150, 151 have the same rotational speed, however, in other embodiments, the rotational speed of compaction rollers 150, 151 may be different.

Rotational directions 156 of compaction rollers 150, 151 are opposite to each other. For example, in FIG. 1, rotational direction 156 of upper compaction roller 150 is clockwise, whereas rotational direction 156 of lower compaction roller 151 is counter-clockwise. However, due to the positioning of compaction rollers 150, 151 above and below, respectively, substrate 105 and dry powder 131, rotational directions 156 are generally in the same direction as feed direction 106 proximal substrate 105 and dry powder 131. In particular, due to the rotational direction 156 of upper compaction roller 150, the lower portion of outer surface 152 of upper compaction roller 150 contacting dry powder 131 moves in the same direction as feed direction 106; and due to the rotational direction 156 of lower compaction roller 151, the upper portion of outer surface 152 of lower compaction roller 151 contacting substrate 105 moves in the same direction as feed direction 106. For example, as shown in FIG. 1, at the point of engagement of outer surface 152 of upper compaction roller 140 with dry powder 131, outer surface 152 of upper compaction roller 150 is generally moving to the left while feed direction 106 is also to the left; and at the point of engagement of outer surface 152 of lower compaction roller 151 with substrate 105, outer surface 152 of lower compaction roller 151 is generally moving to the left while feed direction 106 is also to the left. Accordingly, both compaction rollers 150, 151 may be described as “non-counter-rotating” relative to feed direction 106.

Compaction rollers 150, 151 are vertically-spaced apart a sufficient distance to provide a gap G_{c} measured vertically from the upper surface of substrate 105 to the lowermost portion of outer surface 152 of upper compaction roller 150. Thus, the vertical distance between compaction rollers 150, 151 is equal to the thickness T₁₀₅ plus gap G_{c}. It should be appreciated that gap G_{c} defines the vertical thickness to which dry powder 131 is compacted on substrate 105 by compaction rollers 140, 141 to form electrode 101. Thus, gap G_{c} defines the thickness of electrode 101. In embodiments described herein, gap G_{c}, and hence the vertical thickness of dry powder 131 after passing between compaction rollers 150, 151 and the thickness of electrode 101, ranges from 0 to 2,000.0 micron, and alternatively ranges from 20.0 micron to 200.0 micron.

Referring still to FIG. 1, supply roller 110, receiving roller 120, lower spreading roller 141, and lower compaction roller 151 support substrate 105 (and the components disposed thereon such as dry powder 131 and electrode 101) via direct contact with substrate 105. In this embodiment, air bearings 160 are also provided to contactless support to substrate 105 (and the components disposed thereon such as dry powder 131). Air bearings 160 also reduce vertical vibrations of substrate 105 to allow a more precise transport of substrate 105 (and the components thereon). In embodiments described herein, each air bearing 160 is configured to provide both a positive pressure air cushion 161 (above ambient atmospheric pressure) and a negative pressure suction 162 (below ambient atmospheric pressure) to allow frictionless support of substrate 105 while simultaneously reducing vibrations of substrate 105 for relatively high speed production operations. In embodiments described herein, air bearings 160 preferably minimize vertical vibrations of the portions of substrate 105 horizontally positioned between rollers 110, 120, 140, 141, 150, 152 to less than 3.0 micron (measured vertically from the lowest point of substrate 105 to the highest point of substrate 105).

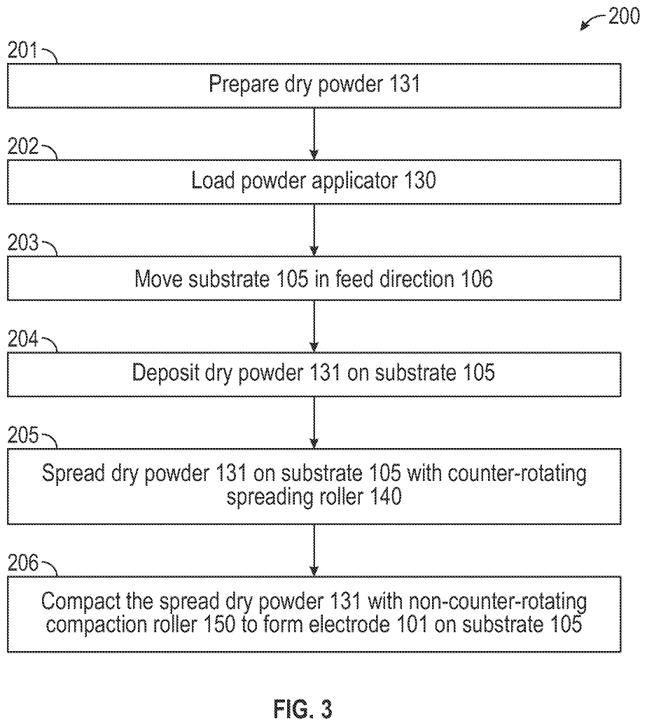

Referring now to FIG. 3, an embodiment of a method 200 for manufacturing electrode 101 on substrate 105 is shown. Method 200 is performed with system 100 previously described and shown in FIG. 1, and thus, will be described with reference to system 100.

In this embodiment, method 200 begins in block 201 in which dry powder 131 is prepared. As described above, dry powder 131 comprises a plurality of nano-particle coated micro-particles (e.g., nano-particle coated micro-particles 193) and is “dry” (i.e., does not include any solvent and is not prepared using any solvent). Next, in block 202, powder applicator 130 is loaded with dry powder 131, and in block 203, substrate 105 is moved in feed direction 106 via rollers 110, 120. Moving now to block 204, dry powder 131 is deposited on substrate 105 via powder applicator 130. Substrate 105 (moving in feed direction 106) transports dry powder 131 through the remainder of system 100. In particular, substrate 105 transports dry powder 131 in feed direction 106 from powder applicator 130 to spreading rollers 140, 141, then from spreading rollers 140, 141 to compaction rollers 150, 151, and then from compaction rollers 150, 151 to receiving roller 120. Thus, rollers 140, 141, 150, 151 may be described as being downstream of powder applicator 130 relative to feed direction 106, compaction rollers 150, 151 may be described as being downstream of spreading rollers 140, 141 and powder applicator 130, and receiving roller 120 may be described as being downstream of rollers 140, 141, 150, 151 and powder applicator 130. During the transport of dry powder 131 through system 100, substrate 105 is vertically supported by rollers 141, 151 and air bearings 160. In addition, air bearings 160 function to reduce vibration of substrate 105 as previously described.

Referring still to FIG. 3, substrate 105 transports dry powder 131 between spreading rollers 140, 141, which spread dry powder 131 over substrate 105. Several features of system 100 are specifically designed and configured to ensure an even, uniform spreading of dry powder 131 to the desired thickness defined by gap Gₛ. In particular, system 100 includes friction enhancing coating 108 that contacts dry powder 131, low friction outer surface 142 of upper spreading roller 140 that contacts dry powder 131, counter-rotating spreading rollers 140, 141 that move in rotational directions 146 generally opposite to feed direction 106 proximal dry powder 131, and high precision spreading rollers 140, 141 (manufactured and oriented relative to each other with relatively tight tolerances with respect to radial run-out error and roller parallelism) to ensure an even, uniform spreading of dry powder 131 to the desired thickness defined by gap Gₛ. Moving now to block 206, substrate 105 transports the spread dry powder 131 between compaction rollers 150, 151, which compact dry powder 131 on substrate 105 to form electrode 101.

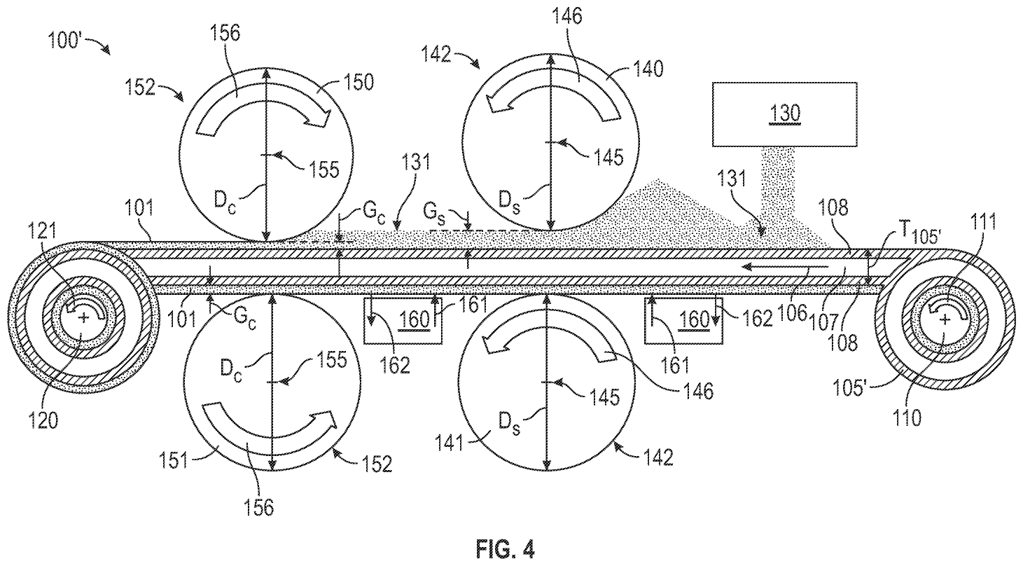

In the embodiment of system 100 shown in FIG. 1 and described above, electrode 101 is formed on one side of substrate 105. However, in other embodiments, an electrode can be formed on both sides of the substrate. For example, referring now to FIG. 4, an embodiment of a system 100′ for dry manufacturing electrodes for energy storage devices such as Li-ion batteries and all solid-state batteries is shown. System 100′ is substantially the same as system 100 previously described with the exception that system 100′ produces a continuous sheet or layer of electrode material 101 on both sides of a substrate 105′. Accordingly, features of system 100′ that are the same as system 100 will be given the same reference numerals, and for purposes of clarity and conciseness will not be described in detail with the understanding such common features are the same as previously described with respect to system 100. The electrode material 101 and substrate 105′ can be cut as desired to produce a plurality of individual electrodes for use in energy storage devices, and thus, for purposes of clarity and further explanation, each layer of electrode material 101 may also be referred to herein as an electrode 101.

Referring still to FIG. 4, in this embodiment, system 100′ includes a supply roller 110, a receiving roller 120 horizontally spaced from the supply roller 110, a powder applicator 130, a pair of spreading rollers 140, 141, a pair of compaction rollers 150, 151, and a plurality of air bearings 160, each as previously described. Supply roller 110 generally provides a continuous sheet of substrate 105′ on which electrodes 101 are formed with system 100′, and receiving roller 120 generally receives the continuous sheet of substrate 105′ and electrode(s) 101 formed thereon.

Substrate 105′ is similar to substrate 105 previously described. In particular, substrate 105′ comprises a conductive base 107 in the form of a sheet of conductive material and a friction enhancing coating 108 applied to the upper surface of base 107. However, in this embodiment, a friction enhancing coating 108 is also applied to the lower surface of base 107. To manufacture electrodes 101 on both sides of substrate 105′, substrate 105′ is passed through system 100′ twice. More specifically, substrate 105′ is passed through system 100′ a first time to form electrode 101 on the upper surface of substrate 105′, and then substrate 105 is flipped over and passed through system 100′ a second time to form electrode 101 on the upper surface of substrate 105′, which was the lower surface of substrate 105′ on the first pass through system 100′. The first pass of substrate 105′ through system 100′ to form electrode 101 on one side of substrate 105′ is the same as previously described. The second pass of substrate 105′ through system 00′ to form the electrode 101 on the opposite side of substrate 105′ is the same as previously described except that the vertical distance between lower spreading roller 141 and substrate 105′, the vertical distance between lower compaction roller 151 and substrate 105′, and the vertical distance between air bearings 160 and substrate 105′ are increased by gap G_{c} to accommodate the previously formed electrode 101 vertically positioned between rollers 141, 151 and substrate 105′ and vertically positioned between air bearings 160 and substrate 105′.

In the manner described, embodiments of systems (e.g., systems 100, 100′) and methods (e.g., method 200) described herein can be used to dry manufacture electrodes for energy storage devices such as batteries (e.g., lithium ion batteries, solid state batteries, etc.). Such embodiments offer the potential for several advantages over conventional systems and methods. In particular, embodiments described herein can increase dry powder and electrode uniformity, and are applicable to a wide range of electrode compositions. In addition, the use of “dry” powder to form electrodes in accordance with embodiments described herein can reduce manufacturing costs, manufacturing equipment footprint, and energy consumption by eliminating the need for solvent drying and recovery.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

1. A system for dry manufacturing an electrode for a battery, the system comprising:
a substrate configured to move in a feed direction;
a powder applicator configured to deposit a dry powder onto a surface of the substrate, wherein the dry powder comprises a plurality of nano-particle coated micro-particles, wherein each micro-particle has a size greater than or equal to 1.0 micron and each nano-particle has a size less than 1.0 micron;
at least one pair of spreading rollers, wherein the at least one pair of spreading rollers comprises an upper spreading roller and a lower spreading roller positioned below the upper spreading roller, wherein the upper spreading roller and the lower spreading roller are positioned downstream of the powder applicator relative to the feed direction, wherein each spreading roller has a central axis of rotation and a radially outer surface, wherein the radially outer surface of the upper spreading roller is configured to directly contact and spread the dry powder on the substrate; and
at least one pair of compaction rollers, wherein the at least one pair of compaction rollers comprises an upper compaction roller and a lower compaction roller positioned below the upper compaction roller, wherein the upper compaction roller and the lower compaction roller are positioned downstream of the at least one pair of spreading rollers relative to the feed direction, wherein each compaction roller has a central axis of rotation and a radially outer surface, wherein the radially outer surface of the upper compaction roller is configured to directly contact and compress the dry powder to form the electrode on the surface of the substrate.

2. The system of claim 1, wherein the upper spreading roller is spaced above the surface of the substrate by a gap Gs and the upper compaction roller is spaced above the surface of the substrate by a gap Gc, wherein the gap Gc is less than the gap Gs.

3. The system of claim 2, wherein the gap Gs and the gap Gc each range from 0 to 2,000 micron.

4. The system of claim 3, wherein the gap Gs ranges from 20.0 micron to 500.0 micron and the gap Gc ranges from 20.0 micron to 200.0 micron.

5. The system of claim 1, wherein the substrate comprises a conductive base and a friction enhancing coating applied to the conductive base.

6. The system of claim 5, wherein the conductive base comprises a sheet of conductive foil and the friction enhancing coating comprises carbon.

7. The system of claim 5, wherein a coefficient of friction μ_{roller-powder} between the radially outer surface of the first spreading roller and the dry powder is less than a coefficient of friction μ_{substrate-powder} between the friction enhancing coating of the substrate and the dry powder.

8. (canceled)

9. The system of claim 1, further comprising an air bearing is positioned below the substrate and supports the substrate, and wherein the air bearing is configured to reduce vibration of the substrate.

10. The system of claim 1, wherein the radially outer surface of the lower spreading roller contacts and supports the substrate;
wherein each spreading roller has a radial run-out error less than or equal to 3.0 micron;
wherein the central axis of the upper spreading roller and the central axis of the lower spreading roller exhibit a roller parallelism less than or equal to 5.0 micron.

11. The system of claim 1, wherein the dry powder comprises:
an active material; and
a binder.

12. The system of claim 11, wherein the active material comprises:
a cathode material selected from the group consisting of lithium nickel-cobalt-manganese oxide (NMC), lithium iron phosphate (LFP), lithium cobalt oxide (LCO), or a combination thereof; or
an anode material selected from the group consisting of graphite, a carbonaceous anode material, a lithium transition metal oxide, an Si-based composites, or a combination thereof.

13. The system of claim 11, wherein the dry powder further comprises a solid state electrolyte.

14. The system of claim 11, wherein the binder comprises a polymeric material, a solid state electrolyte, or a combination thereof.

15. The system of claim 11, wherein the dry powder further comprises electrically conductive materials.

16. The system of claim 1, wherein the substrate has a thickness that ranges from 1.0 micron to 30.0 micron.

17. A method for dry manufacturing an electrode for an energy storage device, the method comprising:
(a) depositing a dry powder onto a surface of a substrate moving in a feed direction, wherein the dry powder comprises a plurality of nano-particle coated micro-particles, wherein each micro-particle has a size greater than or equal to 1.0 micron and each nano-particle has a size less than 1.0 micron;
(b) transporting the dry powder on the substrate beneath a first spreading roller rotating in a first rotational direction to spread the dry powder on the substrate after (a); and
(c) transporting the dry powder with the substrate beneath a compaction roller rotating in a second rotational direction to compress the dry powder composition after (b) and produce the electrode on the surface of the substrate.

18. The method of claim 17, wherein (b) comprises rotating the first spreading roller at a first rotational speed and (c) comprises rotating the compaction roller at a second rotational speed, wherein the first rotational speed ranges from 0.1 to 200.0 RPM and the second rotational speed ranges from 0.1 to 80.0 RPM.

19. The method of claim 17, wherein (b) comprises spreading the dry powder to a first thickness measured from the surface of the substrate to the first spreading roller and (c) comprises compressing the dry powder to a second thickness measured from the surface of the substrate to the compaction roller, wherein the second thickness is less than the first thickness.

20. The method of claim 19, wherein the first thickness and the second thickness each range from 0.0 to 2,000.0 micron.

21. The method of claim 20, wherein the first thickness ranges from 20.0 micron to 500.0 micron and the second thickness ranges from 20.0 micron to 200.0 micron.

22. The method of claim 17, wherein the substrate comprises a conductive base and a friction enhancing coating applied to the conductive base, wherein the dry powder is deposited onto the friction enhancing coating of the substrate in (a).

23. The method of claim 17, wherein the first spreading roller has a radially outer surface that contacts and spreads the dry powder in (b), wherein a coefficient of friction μ_{roller-powder} between the radially outer surface of the first spreading roller and the dry powder is less than a coefficient of friction μ_{substrate-powder} between the friction enhancing coating of the substrate and the dry powder.

24. (canceled)

25. The method of claim 17, further comprising:
(d) supporting the substrate during (a), (b), and (c) with one or more air bearings is positioned below the substrate;
(e) reducing vibration of the substrate during (a), (b), and (c) with the one or more air bearings by providing both a positive pressure air cushion and a negative pressure suction to the substrate with the one or more air bearings.

26. The method of claim 17, wherein (b) further comprises:
transporting the dry powder on the substrate over a second spreading roller rotating in the first rotational direction;
contacting the substrate with the second spreading roller;
wherein each spreading roller has a central axis of rotation and a radially outer surface, wherein each spreading roller has a radial run-out error less than or equal to 3.0 micron, and
wherein the central axis of the first spreading roller and the central axis of the second spreading roller exhibit a roller parallelism less than or equal to 5.0 micron.

27. The system of claim 1, wherein the upper spreading roller is configured to rotate in a rotational direction that is counter to the feed direction of the substrate proximal the substrate and dry powder, and the lower spreading roller is configured to rotate in a rotational direction that is the same as the rotational direction of the upper spreading roller.

28. The system of claim 27, wherein the upper compaction roller is configured to rotate in a rotational direction that is opposite to a rotational direction of the upper spreading roller.

29. The system of claim 1, wherein the upper compaction roller is configured to rotate in a rotational direction that is opposite to a rotational direction of the upper spreading roller.

30. The method of claim 17, wherein the first rotational direction is counter to the feed direction at a point of contact of the first spreading roller with the dry powder, and wherein the second rotational direction is opposite to the first rotational direction.

31. The system of claim 1, wherein one or more of the micro-particles comprises an active material; and
wherein one or more of the nano-particles comprises a conductive additive or a solid state electrolyte.

32. The method of claim 17, wherein one or more of the micro-particles comprises an active material; and
wherein one or more of the nano-particles comprises a conductive additive or a solid state electrolyte.
